(19) United States
(12) Patent Application Publication
(10) Pub. No.: US 2005/0066189 A1
(43) Pub. Date: Mar. 24, 2005

(54) Methods and structure for scan testing of secure systems

(76) Inventors: Robert Moss, Longmont, CO (US); Michael Howard, San Jose, CA (US)

Correspondence Address: LSI LOGIC CORPORATION, 1621 BARBER LANE, MS: D-106, MILPITAS, CA, 95035, US

(21) Appl. No.: 10/667,021

(22) Filed: Sep. 18, 2003

(51) Int. Cl. H04L 9/00

(52) U.S. Cl. 713/200; 714/726

(57) ABSTRACT

Circuit structures and associated methods of operation for preventing retrieval of secure information within an integrated circuit by unauthorized use of scan test operation of the integrated circuit. Features and aspects of the invention provide for intercepting scan test related signals within the integrated circuit and for applying an internally generated reset signal to clear any secure information presently loaded into the integrated circuit and stored in flip-flop, register or other memory elements within the integrated circuit. The internally generated reset may be applied prior to entry to scan test to clear any secure information within the integrated circuit at scan test entry. The internally generated reset may also be applied at scan test exit to clear secure information that may be revealed by continued normal operation following scan test operation.

### BACKGROUND OF THE INVENTION

1. Field of the Invention

The present invention relates to integrated circuits that include “scan test” features to permit testing of the integrated circuit. More specifically, the present invention relates to methods and structure for preventing secure information within such an integrated circuit from being revealed through such scan test testing.

2. Discussion of Related Art

Integrated circuits are electronic devices in which numerous discrete electronic components are integrated into a single die or package. As technology has advanced, integrated circuits are ever more densely populated with numerous such discreet electronic circuits. Present day integrated circuits may comprise millions or even tens of millions of discrete electronic circuits within a single package or die. Such complex integrated circuits may include, for example, customizable application specific integrated circuits (so-called ASICs) as well as commercial integrated circuits such as device controller and processor integrated circuit devices.

It is in ongoing problem to effectively test such complex integrated circuit designs. Prior to the advent of such dense integrated circuits, printed circuit boards populated with numerous discrete components could be easily tested by applying probes and associated analyzers to various signal paths and electronic components to test input and output signal quality and timing. However, it is impossible to apply such testing techniques to integrated circuits—let alone to dense integrated circuits. No external analyzer can be effectively applied to the various discrete components integrated within the integrated circuit die or package.

Numerous well known techniques have evolved for permitting the testing of complex integrated circuits. One known technique is often referred to as “scan test.” A scan test enable signal may be applied to the integrated circuit to invoke a scan test structure of logic features within the integrated circuit. In particular, scan test features typically allow a sequence of binary values to be shifted into register or flip-flop memory elements within the integrated circuit. A clock signal may then be applied to the integrated circuit during the scan test to cause the normal functioning of the integrated circuit to process one clock cycle. Next the information as modified by the single clock normal operation of the circuit is shifted out of the circuit using scan test signals to view the results of the single clock operation on the loaded scan test values. The output bits are applied to an output signal path of the integrated circuit to permit external analysis and verification of operation of tested features of the integrated circuit. Shifted bit values applied to the output signal path may be compared to expected values to verify proper operation and connectivity among the various register and flip-flop memory elements in the integrated circuit package.

A problem arises in permitting such scan test operation where secure information may be present within the integrated circuit. Secure information may include, for example, password or encryption key information intended for securing data within the integrated circuit or for securing transmissions from the integrated circuit. Present scan test operation may permit an unauthorized user to view such secure information by forcing the integrated circuit into a scan test and viewing the output information applied to the output of the integrated circuit.

It is evident from the above discussion that a need exits for an improved test feature in integrated circuits to assure security of a secure or confidential information within the integrated circuit.

### SUMMARY OF THE INVENTION

The present invention solves the above and other problems, thereby advancing the state of the useful arts, by providing structure and associated methods to preclude use of scan test features of an integrated circuit to view secure information within the integrated circuit. More specifically, one aspect of the present invention includes logic within the integrated circuit to intercept scan test related signals and force a reset of secure portions of the integrated circuit upon entry and exit of scan test. Such an internally generated reset signal will help assure that any secure information presently residing in the integrated circuit will be reset to a power on state during operation of scan testing.

One feature hereof therefore provides an integrated circuit having scan test features and including: a scan test signal interceptor for intercepting scan test related signals applied to the integrated circuit; and a security element responsive to the scan test signal interceptor to preclude retrieval of secure information within the integrated circuit using the scan test related signals.

Another aspect hereof further provides that the security element comprises: a reset generator to reset secure information within the integrated circuit.

Another aspect hereof further provides that the scan test signal interceptor is operable to sense a request to enter scan test.

Another aspect of the invention further provides that the reset generator is operable to reset secure information in response the request to enter scan test.

Another aspect of the invention further provides that the scan test signal interceptor is operable to sense a request to exit scan test.

Another aspect of the invention further provides that the reset generator is operable to reset secure information in response the request to exit scan test.

Another feature of the invention provides a method operable within an integrated circuit to prevent unauthorized access to secure information, the method comprising: detecting application of a scan test related signal to the integrated circuit; and precluding access to the secure information in response to detection of the scan test related signal.

Another aspect hereof further provides that the step of precluding includes: resetting elements of the integrated circuit to reset the secure information.

Another aspect hereof further provides that the step of detecting includes: detecting a signal applied to the integrated circuit requesting entry to scan test.

Another aspect hereof further provides that the step of resetting includes: resetting elements of the integrated circuit in response to detection of the request to enter scan test.

Another aspect hereof further provides that the step of detecting includes: detecting a signal applied to the integrated circuit requesting exit from scan test.

Another aspect hereof further provides that the step of resetting includes: resetting elements of the integrated circuit in response to detection of the request to exit scan test.

### BRIEF DESCRIPTION OF THE DRAWINGS

FIG. 1 is a block diagram of an integrated circuit having scan test features as presently known in the art.

FIG. 2 is a block diagram of an exemplary integrated circuit having secure scan test features.

FIG. 3 is a flowchart of an exemplary secure scan test process.

FIG. 4 is a timing diagram of signals in associated with an exemplary secure scan test circuit and process.

FIG. 5 is a block diagram of signals useful in an exemplary secure scan circuit and process.

### DETAILED DESCRIPTION OF THE DRAWINGS

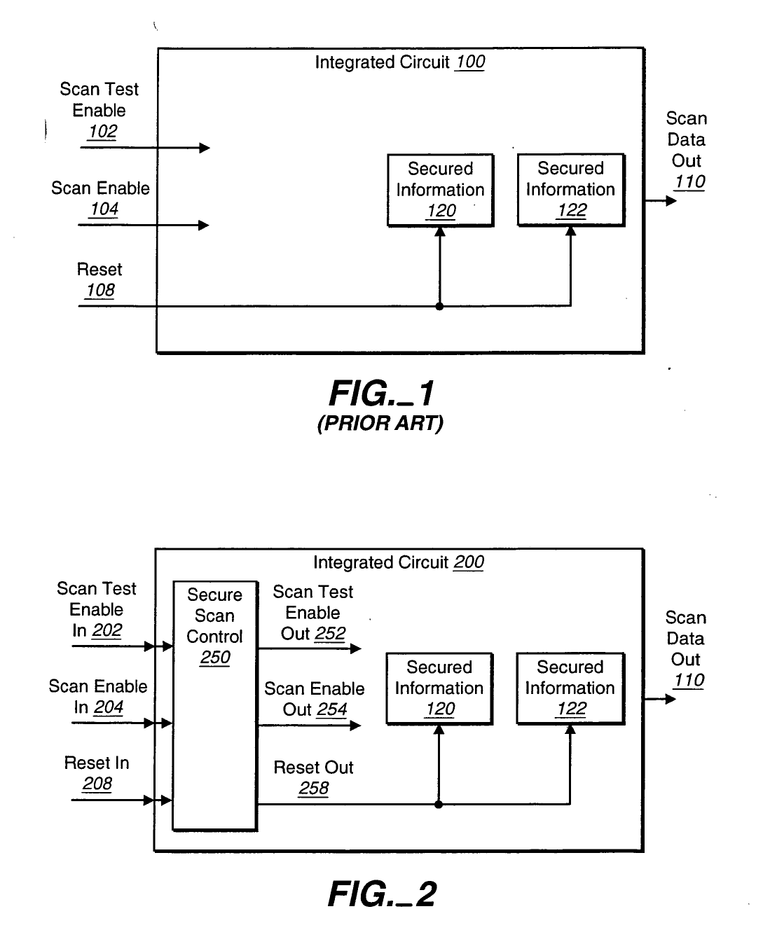

FIG. 1 is a block diagram of a typical integrated circuit having scan test features as presently practiced in the art. As discussed above, present day integrated circuits often include a scan test feature to permit testing of memory elements within the integrated circuit (i.e., flip-flops and registers) and interconnecting conductive paths within such an integrated circuit. Integrated circuit 100 as presently practiced in the art may include secured information 120 and 122 in memory elements such as flip-flops and registers of the integrated circuit. Often, a reset signal 108 is coupled to such memory components to permit the integrated circuit 100 to be reset to a known initial state. A scan test signal 102 and a scan enable signal 104 may be applied to the integrated circuit 100 to shift test data through flip-flops and registers of the integrated circuit 100. As test data is shifted through the integrated circuit, the data may be applied to an output signal path scan data out 110 for external analysis and verification of the scan test operation.

As noted above, present integrated circuit designs may permit unauthorized access to secured information 120 and 122. A skilled engineer may force the integrated circuit 100 into scan test operation following the loading of secured information into memory elements such as flip-flops and registers. By then enabling scan test operation, the secured information may be accessed by observing data shifted out and applied to scan data out 110 of the integrated circuit.

Secured information 120 and 122 may be stored in flip-flops and registers within the integrated circuit 100. Other forms of memory components are well known to those of ordinary skill in the art and may also be incorporated within such an integrated circuit 100 for purposes of storing secured information. Although the present invention is directed primarily at secured information stored in volatile flip-flop and register memory components, a similar design may be applicable to other memory components within an integrated circuit 100 that may store secured information.

Those of ordinary skill in the art will readily understand the design and operation of typical scan test features of an integrated circuit. In general, scan test signal 102 may be applied to force the integrated circuit 100 into scan test operation. A second scan enable signal path 104 may be applied to actually commence the shifting of data on sequential clock cycles for purposes of evaluating operation of the integrated circuit 100. Numerous variations for such scan test operation will be readily apparent to those of ordinary skill in the art.

By contrast to FIG. 1, integrated circuit 200 of FIG. 2 includes a secure scan control element 250 to preclude operation of integrated circuit 200 in scan test in such a manner as to permit unauthorized access to secured information 120 and 122. As above, secured information 120 and 122 may be flip-flop or register memory components or other similar memory components storing volatile secured information within the integrated circuit 200. As also noted above, exemplary secured information may include password or encryption key information or any other form of secure information for which unauthorized access is to be denied. A scan test in signal 202 and a scan enable in signal 204 may be applied to integrated circuit 200 similar to signals applied as discussed above with respect to FIG. 1. Reset in signal 208 may be applied to integrated circuit 200 by any external device for purposes of resetting integrated circuit 202 to a known initial state. Secure scan element 250 receives such applied signals and modifies the signals as applied within the integrated circuit 200 to preclude unauthorized access to secured information 120 and 122.

In one embodiment, scan test out 252 and scan enable out 254 are deferred or delayed in their respective application to memory elements storing secured information 120 and 122 until after an appropriate reset signal generated internally by secure scan control 250 clears or resets any secured information within integrated circuit 200. More specifically, reset out signal 258 is first generated by secure scan control 250 and applied to clear secured information 120 and 122 before scan test related signals (252 and 254) are applied to the memory components storing such information. In effect, secure scan control 250 forces an internally generated reset signal to be applied to memory elements within the integrated circuit that may contain secure information. The internally generated reset may be generated and applied to such memory components upon entry into scan test and again upon exit from scan test.

Reset out 258 may be generated internal to integrated circuit 200 by secure scan control 250 and may effectively reset or clear any secured information from flip-flops, registers or other volatile memory components within integrated circuit 200. In particular, the internally generated reset signal applied to reset out 258 may reset secured information 120 and 122. By so clearing such secured information prior to commencing scan test operation, unauthorized access to secured information 120 and 122 by use of scan test operation may be prevented. More specifically, any information scanned out of integrated circuit 200 applied to scan data out 110 will be devoid of secured information within memory elements 120 and 122. Since the reset signal is generated internally by the improved integrated circuit 200, an external user of the device cannot bypass the security feature to thereby gain unauthorized access to the secured information 120 and 122 by use of scan test features.

As discussed further herein below, the internally generated reset signal may be generated at entry to scan test, at exit from scan test or both. Entry to and exit from scan test are indicated by signals applied to the integrated circuit 200 by a user of same. Features and aspects hereof may detect the entry to and exit from scan test to generate the desired reset of secured information.

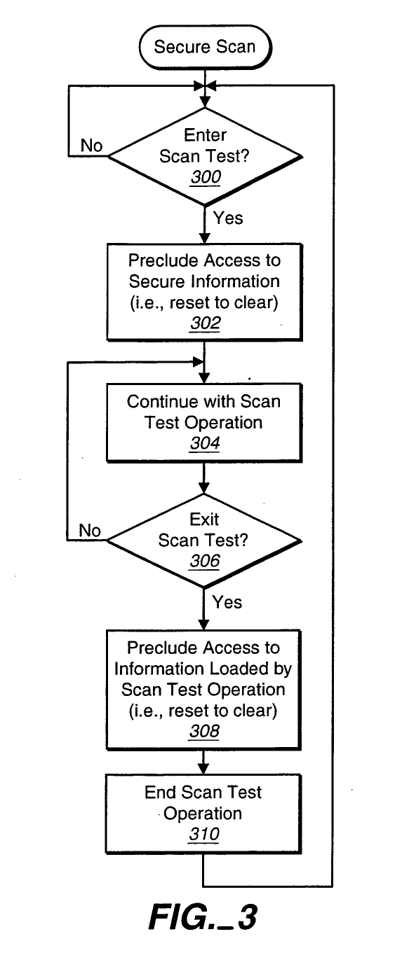

FIG. 3 is a flowchart describing a process operable within a secure scan control element 250 as described above with respect to FIG. 2. Secure scan processing element 300 first detects a request to enter scan test operation. Upon detection of a scan test entry request, element 302 is next operable to preclude access to secured information within the integrated circuit through use of scan test operation. For example, as noted above, access to secured information may be precluded by forcing generation of a reset signal applied to volatile memory components to clear any secured information therefrom. Element 304 then allows continued operation of the integrated circuit in the requested scan test until element 306 detects a request to exit from scan test operation. Upon detection of a request to exit scan test operation, element 308 may further preclude access to secured information by operation of scan test features. For example, with particular knowledge of the design and operation of an integrated circuit, scan test may be used by unauthorized users to reconfigure information within the integrated circuit such that continued normal following scan test operation may reveal secured information. Element 308 may therefore be operable to again reset or clear secured information from the volatile memory elements within the integrated circuit. As above, the reset is internally generated within the integrated circuit by secure scan control logic and internally applied to appropriate memory elements therein. Element 310 then terminates operation of scan test for the integrated circuits. The integrated circuit may then continue as discussed above awaiting entry to a new scan test and meanwhile performing normal desired functions.

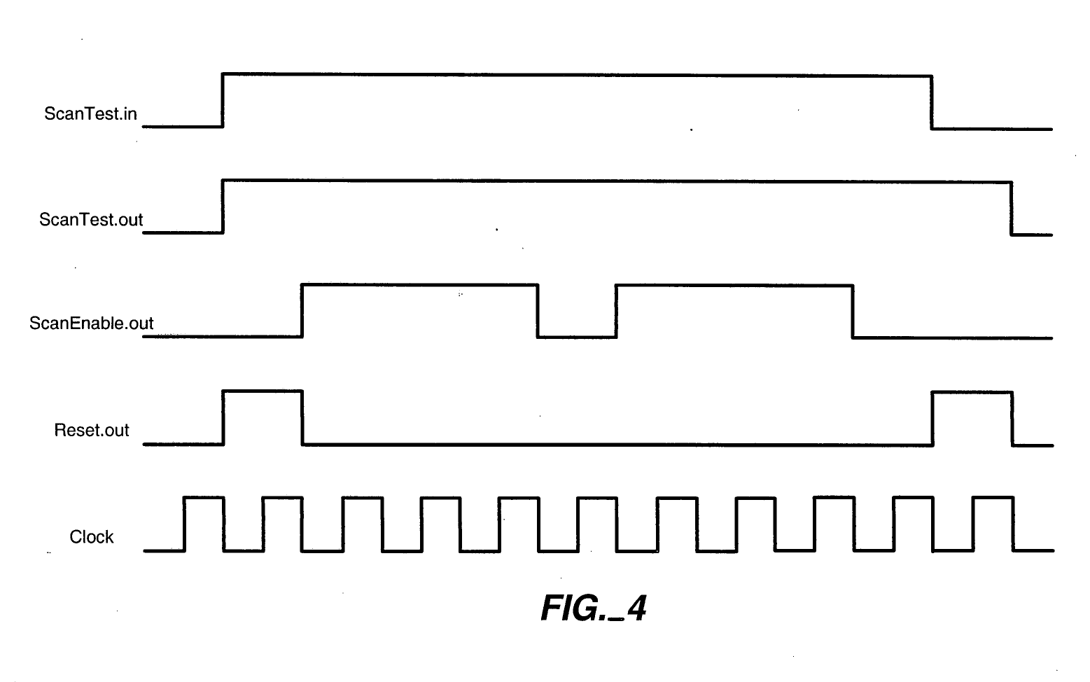

FIG. 4 is a timing diagram describing operation of scan test related signals in the secure scan operations and features hereof. The scan test control logic generally receives the listed “in” signals and generates related “out” signals delayed and modified as needed herein. ScanTest.in represents a signal applied to the integrated circuit and applied internally therein to a secure scan element indicating a request to enter scan test operations. Upon detection of a scan test entry request (detecting an active signal on the ScanTest.in) the Reset.out signal may be generated internally by scan control logic and appropriately asserted or pulsed to force a reset of secured information within the integrated circuit during scan test operation. Upon completion of the reset, the ScanEnable.out signal maybe asserted (and de-asserted as necessary) to initiate and complete scan test operation of the integrated circuit. The ScanTest.out signal is, in essence a delayed version of the ScanTest.in signal—delayed until after completion of the internally generated reset cycle of the integrated circuit. When the ScanTest.in signal path is eventually de-asserted indicating exit of scan test operation, another Reset.out signal may be internally generated by the secure scan features hereof to again clear secured information from the integrated circuit prior to resuming normal operation. ScanEnable.out is pulsed largely in synchronicity with the correspond ScanEnable.in signal (not shown) to start and stop clocking of signals in the scan test operation. As noted above, such scan test feature operation is generally known to those skilled in the art.

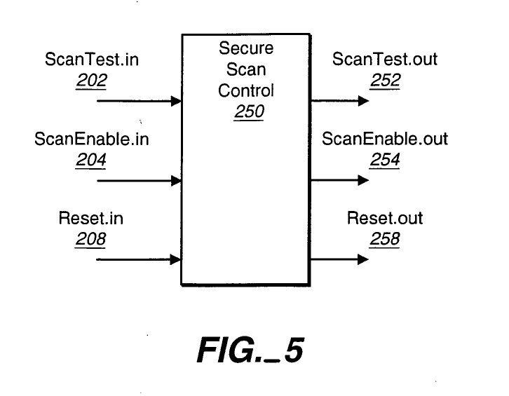

FIG. 5 is a block diagram of exemplary signals discussed above with respect to the timing diagram of FIG. 4. The “in” signals are generated external to the integrated circuit and applied as inputs to secure scan components hereof within an integrated circuit and associated systems. Corresponding “out” signals are generated within the integrated circuit to control scan test operation while precluding unauthorized access to secure information.

In one exemplary embodiment, the following pseudo-code segment referring to the signals of FIG. 5 may be provided to implement features hereof. Logic gates to provide these features will be readily apparent to those skilled in the art.

ScanTestEntryReset<=edge_detect (ScanTest.in, active)

ScanEnable.out<=ScanEnable.in //may be forced inactive until after ScanTestEntryReset if necessary

ScanTestExitReset<=edge detect (ScanTest.in, inactive)

ScanTest.out<=ScanTest.in //may be forced active until after ScanTestExitReset if necessary

Reset.out<=Reset.in OR ScanTestEntryReset OR ScanTestExitReset

While the invention has been illustrated and described in the drawings and foregoing description, such illustration and description is to be considered as exemplary and not restrictive in character. One embodiment of the invention and minor variants thereof have been shown and described. Protection is desired for all changes and modifications that come within the spirit of the invention. Those skilled in the art will appreciate variations of the above-described embodiments that fall within the scope of the invention. As a result, the invention is not limited to the specific examples and illustrations discussed above, but only by the following claims and their equivalents.

1. An integrated circuit having scan test features and including:
a scan test signal interceptor for intercepting scan test related signals applied to the integrated circuit; and
a security element responsive to the scan test signal interceptor to preclude retrieval of secure information within the integrated circuit using the scan test related signals.

2. The integrated circuit of claim 1 wherein the security element comprises:
a reset generator to reset secure information within the integrated circuit.

3. The integrated circuit of claim 2 wherein the scan test signal interceptor is operable to sense a request to enter scan test.

4. The integrated circuit of claim 3 wherein the reset generator is operable to reset secure information in response the request to enter scan test.

5. The integrated circuit of claim 2 wherein the scan test signal interceptor is operable to sense a request to exit scan test.

6. The integrated circuit of claim 5 wherein the reset generator is operable to reset secure information in response the request to exit scan test.

7. A method operable within an integrated circuit to prevent unauthorized access to secure information, the method comprising:
detecting application of a scan test related signal to the integrated circuit; and
precluding access to the secure information in response to detection of the scan test related signal.

8. The method of claim 7 wherein the step of precluding includes:
resetting elements of the integrated circuit to reset the secure information.

9. The method of claim 7 wherein the step of detecting includes:
detecting a signal applied to the integrated circuit requesting entry to scan test.

10. The method of claim 9 wherein the step of resetting includes:
resetting elements of the integrated circuit in response to detection of the request to enter scan test.

11. The method of claim 9 wherein the step of detecting includes:
detecting a signal applied to the integrated circuit requesting exit from scan test.

12. The method of claim 11 wherein the step of resetting includes:
resetting elements of the integrated circuit in response to detection of the request to exit scan test.

13. A system including an integrated circuit having a scan test capability, the system comprising:
means for detecting scan test operation of the integrated circuit; and
means for precluding retrieval of secure information within the integrated circuit in response to detecting scan test operation.

14. The system of claim 13 wherein the means for precluding includes:
reset means for resetting the secure information within the integrated circuit to preclude retrieval thereof using scan test operation.

15. The system of claim 14 wherein the reset means is operable to generate a reset within the integrated circuit in response to sensing entry to scan test of the integrated circuit.

16. The system of claim 14 wherein the reset means is operable to generate a reset within the integrated circuit in response to sensing exit from scan test of the integrated circuit.
